(19) United States
(12) Patent Application Publication
(10) Pub. No.: US 2009/0271951 A1
(43) Pub. Date: Nov. 5, 2009

(54) HAND GRIPS WITH GEL STRESS RELIEVING INSERTS

(76) Inventor: Wen Hao, City of Industry, CA (US)

Correspondence Address: LACKENBACH SIEGEL, LLP, LACKENBACH SIEGEL BUILDING, 1 CHASE ROAD, SCARSDALE, NY, 10583, US

(21) Appl. No.: 12/115,267

(22) Filed: May 5, 2008

(51) Int. Cl. B25G 1/10; B25B 7/00

(52) U.S. Cl. 16/430; 81/427.5

(57) ABSTRACT

Hand grip for hand tools and the like contains a plurality of elastomeric compositions to protect the users hand during use. As proposed a plurality of gel inserts are provided with varying degrees of hardness and density to provide an improved ergonomic design while insuring the integrity of the handle.

### BACKGROUND OF THE INVENTION

1. Field of the Invention

This invention generally relates to hand grips, for hand tools and the like, and, more specifically to such hand grips with “gel” stress relieving inserts. Description of the Prior Art:

Hand grips for handles have normally been ergonomically designed to be more comfortable to the user and produce less stress concentration points on the user's hand when the user applies squeezing forces to the handles. Thus, numerous handles have been designed with shapes that generally conform to the shape of the hand to avoid sharp edges or points that may create excessive stress points applied to the user's hand that may result in injury or pain to the user.

Handles have also been made, for a long time, out of materials that tend to minimize stress concentration points on a user's hand, rubber or elastomeric materials having been used that may or may not initially conform to the shape of the user's hand are deformed during use to essentially conform to the user's hand and thereby providing the desired effect. Typical of products that include such ergonomic handles or hand grips include striking tools, such as hammers, and a wide range of squeezing tools such as pliers, cutters and the like that must be forcefully squeezed by the fingers of the hand. In such hand tools, for example, significant forces must be applied by the user's hand and these forces can be especially stressful and painful unless the hand tool is provided with suitable hand grips that minimize or eliminate stress concentration points.

For example, in U.S. Pat. No. 6,647,582 a Stress Relieving Gel Handle is disclosed for use with a hair brush. The handle of the hair brush includes a handle region that includes a stem provided with a deformable grip located thereon. The grip includes an outer layer in the form of a resilient sleeve surrounding the stem. A deformable viscous material is provided between the stem and the resilient sleeve. While such sleeve can, therefore, deform it is neither designed nor is it suitable for application of the very high forces that need to be applied to the handle or handles of a hand tool, such as a pair of pliers or cutters.

Pliable handles are also disclosed in U.S. Pat. Nos. 6,968,599 and 7,234,205. In these patents, the handle is provided with a tubular core and a deformable outer sheath is arranged about the tubular core. Gel is disposed between the tubular core member and the outer sheath, as in the aforementioned patent.

In U.S. Pat. No. 6,959,469 a pliable header is disclosed for a hand held device. As in the previous mentioned patents, there is provided a core member and an outer sheath, with gel being disposed between the core member and the outer sheath. The pliable handle is designed to deform and conform to the shape of the user's hand. The applied force causes movement of the gel, the pliable handle having a “memory effect” that causes the handle to temporarily deform for a period of time to the deformed shape before the handle returns to its original shape.

As with the previous described prior art, while such deformable handles may make it somewhat more comfortable for the user to hold the handles, they are not adapted to be exposed to the much higher forces that are typically applied to hand tools, such as pliers, wrenches, cutters, and the like. The gel used in the aforementioned prior art devices is generally very soft so that there is significant and rapid deformation as soon as even the slightest forces are applied. However, because the gel is contained within an outer tubular shell or sheath it must be relatively thin and flexible. Application of excessive forces to such sheath may cause internal pressures to be created that could damage the sheath or rupture it and render the handle unusable.

### SUMMARY OF THE INVENTION

Accordingly, it is an object of the invention to provide hand grips for hand tools and the like that do not have the disadvantages inherent in prior hand grips of similar hand grips.

It is another object of the invention to provide hand grips as in the previous objects which are simple in construction and economical to manufacture.

It is still another object of the invention to provide hand grips of the type mentioned in the previous objects that reduces stress points and potential pain and injury to the hand while maintaining the integrity of the handles.

It is yet another object of the invention to provide hand grips as aforementioned that are aesthetically pleasing.

It is further object of the invention to provide hand grips of the type under discussion that can be readily configured or modified for any given application.

In order to achieve the above objects, as well as others which will be, apparent hereafter, hand grips for covering the handles of hand tools or the like comprise portions for covering the handles to which substantial forces are applied by the hand of the user. Said portions define a zone arranged along points of said handles to which maximum forces are applied by the hand of the user. Said forces are generally directed along a predetermined direction. Said zone is formed of a plurality of layers superimposed one upon the other generally along said predetermined direction. Said plurality of layers are formed of resilient materials, each having varying degrees of hardness. The levels of hardness increase from the innermost layer in contact with the handles and decrease in hardness in each successive layer more remotely spaced from said handles. The softest layer is arranged as the outermost layer that makes contact with the hand of the user. Said layers have the property that all of said layers are deformable within their elastic ranges. In this manner, all layers revert to their normal conditions and configurations after the forces applied by the hand of the user are removed while allowing significant forces to be applied to the handles with reduced stresses to the hand by ergonomically deforming to conform to and more uniformly distributing forces applied to the hand to thereby eliminate or significantly reduce the number of stress concentration points applied to the hand.

### BRIEF DESCRIPTION OF THE DRAWINGS

The above and other objects, features and advantages of the present invention will be better understood from the following specification when read in conjunction with the accompanying drawings.

FIG. 1 is a perspective view of a hand tool in the form of a pliers provided with handgrips in accordance with the invention on the handles;

FIG. 2 is another perspective view of the hand tool showing the handgrips on the other handle; and

FIG. 3 is an enlarged exploded view of a handgrip of the invention showing the layered construction.

### DESCRIPTION OF A PREFERRED EMBODIMENT

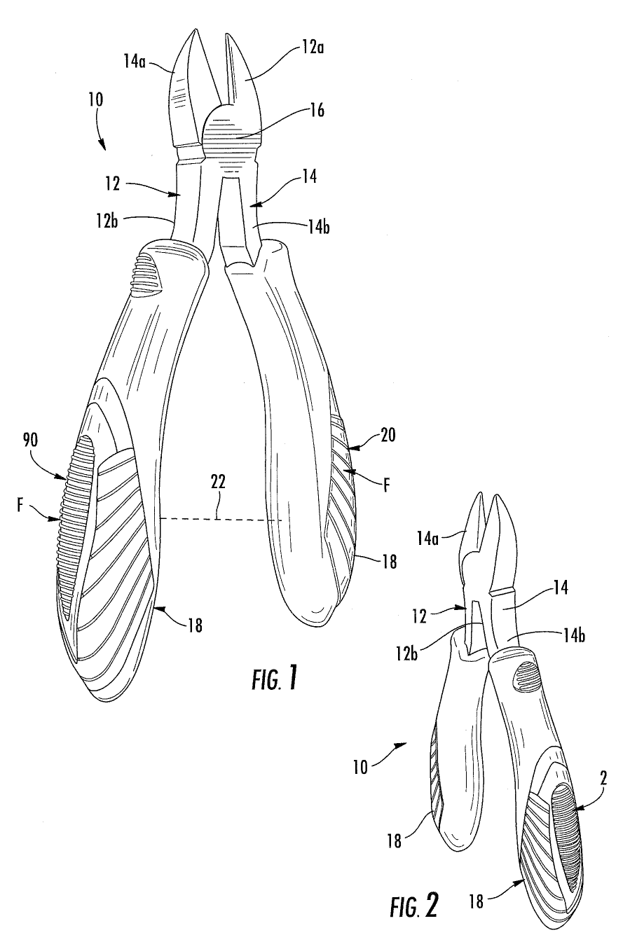

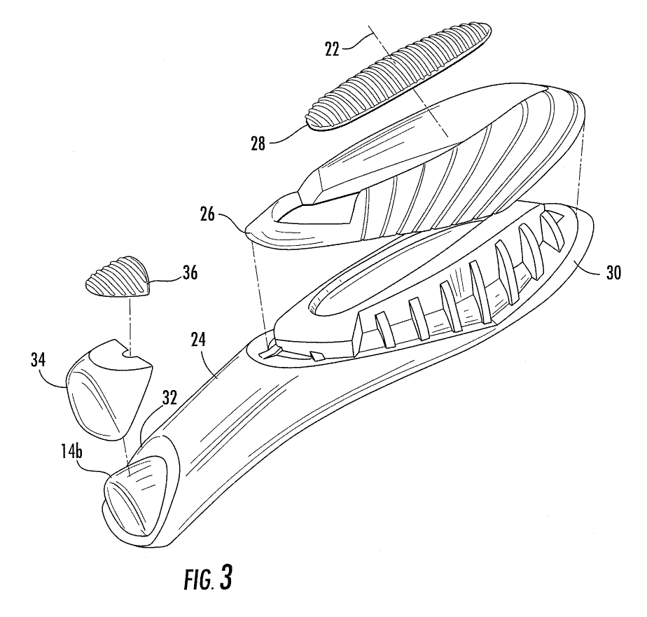

Referring now to the Figures, in which identical or similar parts are designated by the same reference numerals, and first referring to FIGS. 1 and 2, a hand tool in the form of a pliers embodying the present invention is generally designated by the reference 10.

The pliers 10 is mostly of conventional construction with the exception of its handgrips. Thus, the pliers 10 includes two elongate members 12, 14 connected for relative pivoting motion at pivot 16. The elongate member 12 includes a jaw or cutter 12a and handle 12b, while the elongate member 14 includes a jaw or cutter 14a and handle 14b. The operation of the pliers is well known and conventional. Also, while the invention will be described in the context of a pair of pliers it will be evident that the handgrips of the invention can also be used for other hand tools such as, but not limited to, pliers, wrenches, striking tools, and the like.

The hand grips 18 cover the handles 12b, 14b of hand tool or cutter 10, and the handgrips for both handles have the same construction and only one will be described.

The handgrip 18 includes a portion for covering, for example, the handle 14b to which substantial forces F (FIG. 1) are applied by the hand of the user. These portions define a zone 20 arranged along the handle 14b to which maximum forces F are applied by the hand of the user. Such forces are F are generally directed along a predetermined direction 22 (FIGS. 1 and 3).

An important feature of the invention is that the zone 20 is formed of a plurality of layers 24, 26 and 28 superimposed one upon the other generally along the predetermined direction 22. While three layers are shown and will be described in connection with the presently preferred embodiment it will be evident that any number of layers can be used as may be warranted for any given application or as may be dictated by manufacturing considerations or costs.

The plurality of layers 24, 26 and 28 are formed of resilient materials, each having varying degrees of hardness. The levels of hardness increase from the innermost layer 24 in contact with the handle 14b and decrease in hardness in each successive layer more remotely spaced from the handle. The softest layer is arranged as the outermost layer 28 that makes contact with the hand of the user in the region along the zone 20 where maximum squeezing forces are applied. The layers 24, 26 and 28 all have the property that they are deformable within their elastic ranges. This is also controlled by selecting the thicknesses of the layers, especially the softer, more outermost layers. In this manner, all layers revert to their normal conditions and configurations after the forces applied by the hand of the user are removed while allowing significant forces F to be applied to the handles with reduced stresses to the hand by ergonomically deforming, during application of external forces F, to conform to and more uniformly distribute forces applied to the hand to thereby eliminate or significantly reduce the number of stress concentration points applied to the hand.

In the specific example being described, the handle 14b is initially covered by thermoplastic rubber (TPR) that is relatively hard compared to the other layers to be described, and forms the innermost layer 24. The layer 24 has a hardness of 55 on the A Shore Durometer Scale. Generally, the hardness of plastics and softer non-metals is measured by the Shore Durometer test which measures the resistance of a plastic to indentations by a test instrument, such as the Shore Scleroscope or Durometer. Shore hardness uses several scales the two most common of which are the type A and type D scales. The A scale is used for softer plastics, while the D scale is for harder ones, and a material may may be measured on both scales and have a lower value on the D scale and a higher value on the A scale. Up to twelve scales have been established for such measurements depending on their intended use. Each scale results in a value of between 0 and 100, with higher values indicating a harder material. Thus, a hard hat measures 75 on the D Durometer scale, a hard skateboard wheel may measure 98 on the A Durometer scale, a rubber band may measure 25 on the A Durometer scale; and a bicycle gel seat may measure 15-30 on the OO Durometer scale. All the hardness values to be discussed will be with reference to the A Durometer scale.

The initial innermost layer 24 may be injection molded and covers most of the handle portions 12b, 14b, including the zone 20. The innermost layer is a TPR and may included side or lateral ribs as shown, which reduce the weight of the handgrips and, therefore, the hand tool 10 and reduces the amount of TPR used, thereby also reducing the manufacturing costs.

The next outer layer 26 may be a TPR with a hardness of 55 on the A Durometer scale and is harder than the TPR used for the innermost layer 24. The outermost layer 28 is the softest TPR and may measure 20 on the A Durometer scale, being a gel-type substance and having a hardness, as noted above, close to the hardness of 25 on the A Durometer scale for a rubber band. Also, being as soft as it is its thickness is also an important parameter in order to avoid excessive give or flow and loss of control or integrity of the handgrip. In the embodiment being described the thickness of the “gel” layer 36 is approximately 3.5 mm. With this combination the user can feel the soft feeling of the outermost insert 36 as it neutralizes the regions most likely to create stress concentration points against the skin of the user as the user squeezes the handles of the tool. This is, therefore, an important feature of the arrangement which provides thickness for performance. As shown, the exterior surface of the outermost layer 28 may be provided with ribs or ridges 28′ as an outer texture for a feeling of comfort. The placement or positioning of the gel layer, as noted, is placed to optimize ergonomic design. As indicated, the placement of the gel layer 28 is specifically designed to reduce stress at the handle pressure points, with the thickness designed for effective stress relief. If the layer 28 is made too thin it may not be enough to provide the desired effect while if it is made too thick it may not provide sufficient structure. The desired result, therefore, is obtained by considering the combination of layers as well as the structure and hardness of the individual layers. The inner and harder layers are needed to provide the integrity of the handle and the sense or feel of control of the handle, while the medium and softer layers to give the proper ergonomic effect and performance that protects the hand of the user. Unlike prior art structures use of a handle predominantly made of “gel” compromises the structure and integrity of the handle, so the design incorporates the harder interior layers to maintain the structure yet the soft layer provides the comfort while still maintaining the required performance.

In accordance with another feature of the invention is the provision of superimposed TPR layers 34, 36 beyond the zones 20 and arranged proximate to the positions of the tips of the thumb and the pointing finger when the grips are held in the hand of the user when the tool is being used. Referring to FIG. 3, two layers are provided that are, like the layers 24, 26 and 28 in the zone 20, have different degrees of hardness with the harder layers starting at the handles while the more outward layers are softer. In the embodiment shown, the first layer 24 is provided with an inclined or beveled section 32 to expose the innermost portion of the handle 14b. A first layer 34 is made of a TPR having a hardness of approximately 55 on the A Durometer scale that covers the exposed portion of the handle. A second layer 36, like the layer 28, is in the form of a “gel” layer having a hardness of approximately 20 on the A Durometer scale. The layer 36 may likewise be provided with a textured surface in the form of surface raised strips or ribs. When the user squeezes the handles the tips of the thumb and pointing finger may be placed on the layers 34, 36 to allow additional squeezing forces to be applied to the handles and enhances the ergonomic properties of the handles that render same more natural and comfortable to hold especially when the handles are being squeezed by application of significant forces.

While not critical, the layers 24, 26 and 28 as well as the layers 34, 36 are injection-molded and made of different color TPR to make the tool more aesthetically pleasing as well as providing color coding to assist the user in determining where the user is to apply the forces, namely to the colors representing the “gel” layers 28 and 36. In one arrangement the color of the TPR layer 24 is black, the layers 26 and 34 are TPR layers that are gray in color and the layers 28 and 36 are TPR layers that are blue or green translucent colors to suggest a “gel”, assisting the user to position his or her hand and fingers to engage the softer conforming TPR layers.

While the invention has been shown and described in connection with a preferred form of an embodiment it will be understood that modifications may be made without the departure from the scope or spirit of the invention.

What is claimed:

1. Handgrip for covering the handle of hand tools or the like, said handgrip comprising portions for covering the handles to which substantial forces are applied by the hand of a user, said portions defining a zone arranged along points of said handles to which maximum forces are applied by the hand of the user, said forces generally being directed along a predetermined direction, said zone being formed of a plurality of layers superimposed one upon the other generally along said predetermined direction, said plurality of layers being formed of resilient materials each having varying degrees of hardness, the levels of hardness increasing from the innermost layer in contact with the handles and decreasing in hardness in each successive layer; the softest layer being the outermost later that makes contact with the hand of the user, said payers having the property that all said layers are deformable within their elastic ranges, whereby said layers revert to their normal conditions and configuration after the forces applied by the hand of the user are removed while allowing significant forces to be applied to the handles with reduced stress to the hand by ergonomically deforming to conform to and distributing forces applied to the hand to thereby eliminate or significantly reduce the number of stress concentration points applied to the hand.

2. Handgrip as defined in claim 1, wherein at least two layers are provided.

3. Handgrip as defined in claim 2, wherein three layers are provided.

4. Handgrip as defined in claim 1, wherein an outermost layer is a thermoplastic rubber (TPR) having a hardness of approximately 20 on the A Durometer scale.

5. Handgrip as defined in claim wherein three layers are provided with the innermost layer being the hardest with a hardness of approximately 95 on the A Durometer scale, the middle layer having an intermediate hardness of approximately 55 on the A Durometer scale and the outermost layer being the softest with a hardness of approximately of 20 on the A Durometer scale.

6. Handgrip as defined in claim 5, wherein the thickness of the outermost layer being approximately 3.5 mm thick.

7. Handgrip as defined in claim 1, wherein all the layers are made of thermoplastic rubber.

8. Handgrip as defined in claim 1, in combination with a cutting tool.

9. Handgrip as defined in claim 1, in combination with a pliers.

10. Handgrip as defined in claim 1, in combination with a striking tool.

11. Handgrip as defined in claim 1, wherein the TPR for each of the layers are of different colors.

12. Handgrip as defined in claim 1, further comprising superimposed TPR layers beyond said zone and arranged proximate to the tips of the thumb and the pointing finger when said grips are held in the hand of the user when the tool is being used.

13. Handgrip as defined in claim 12, wherein two layers are provided wherein an inner layer has a hardness greater than the hardness of the outer layer.

14. Handgrip as defined in claim 13, wherein said inner layer is a TPR layer having a hardness of approximately 55 on the A Durometer scale while the outermost layer has a hardness of approximately 20 on the A Durometer scale.

15. Handgrip as defined in claim 14, wherein said outermost layer has a thickness of approximately 3.5 mm.

16. Handgrip as defined in claim 15, wherein said layers are TPR materials having different colors.

17. Handgrip as defined in claim 1, wherein said innermost layer is provided with lateral ribs on at least one side of said zone of said innermost layer.

18. Handgrip as defined in claim 17, wherein said lateral ribs are provided to each side of said zone.

19. Handgrip as defined in claim 12, wherein said outermost layer is provided with a surface texture.

20. Handgrip as defined in claim 19, wherein said surface texture comprises surface ribs.
